(19) United States
(12) Patent Application Publication
(10) Pub. No.: US 2023/0267400 A1
(43) Pub. Date: Aug. 24, 2023

(54) ARTIFICIALLY INTELLIGENT WAREHOUSE MANAGEMENT SYSTEM

(71) Applicant: Architecture Technology Corporation, Minneapolis, MN (US)

(72) Inventors: Paul Nicotera, Ithaca, NY (US); Joseph Sirianni, Ithaca, NY (US); Ryan Lee Hagelstrom, Chaska, MN (US); Robert A. Joyce, Ithaca, NY (US); Tyler J. Mitchell, Ithaca, NY (US); Kenneth McVearry, Dewitt, NY (US)

(21) Appl. No.: 18/066,782

(22) Filed: Dec. 15, 2022

Related U.S. Application Data
(60) Provisional application No. 63/362,441, filed on Apr. 4, 2022.
(60) Provisional application No. 63/268,239, filed on Feb. 18, 2022.

(51) Int. Cl. G06Q 10/08; G06N 5/04; G06Q 10/0631; G06Q 10/0639

(52) U.S. Cl. CPC G06Q 10/08; G06N 5/04; G06Q 10/06315; G06Q 10/06393

(57) ABSTRACT

A warehouse management system may receive a predictive analytics request associated with one or more warehouses and may, in response, input data associated with the one or more warehouses into a warehouse management model to determine one or more predictive analytics associated with the one or more warehouses, where the warehouse management model is trained via machine learning to determine the predictive analytics. The warehouse management system may perform simulations of operations of the one or more warehouses based on the one or more predictive analytics to determine one or more warehouse actions to meet one or more operational requirements. The warehouse management system may communicate the one or more warehouse actions to one or more devices associated with the one or more warehouses to enable the one or more devices to operate according to the one or more warehouse actions to meet the one or more operational requirements.

This application claims the benefit of U.S. Provisional Application No. 63/268,239, filed Feb. 18, 2022, and claims the benefit of U.S. Provisional Application No. 63/362,441, filed Apr. 4, 2022, the entire content of each of which is incorporated herein by reference.

### STATEMENT REGARDING FEDERALLY SPONSORED RESEARCH OR DEVELOPMENT

This invention was made with Government support under Contract SP4701-21-P-0084, awarded by the United States Defense Logistics Agency. The Government may have certain rights in this invention.

### BACKGROUND

Warehouses may encounter numerous process challenges due to unavoidable delays, changes in weather, new accounting procedures, employee retention, and the like. Addressing such challenges may result in a massively complex and interconnected system that is difficult for humans to control while meeting performance standards.

### SUMMARY

In general, this disclosure describes techniques for an artificially intelligent warehouse management system that can intelligently manage the operations of a warehouse with or without human interaction. The artificially intelligent warehouse management system may use artificial intelligence, such as machine learning, to optimize warehouse operations and sustainment while providing logistical support for operating the warehouse, such as by implementing high precision data for regular use in warehouse operations and by providing a reliable and robust technology solution that allows warehouses to perform automated tasks without significantly lower operating speeds per existing industry trends.

In some aspects, the techniques described herein relate to a method including: receiving, by one or more processors of a warehouse management system, a predictive analytics request associated with one or more warehouses; in response to receiving the predictive analytics request, inputting, by the one or more processors, data associated with the one or more warehouses into a warehouse management model to determine one or more predictive analytics associated with the one or more warehouses, wherein the warehouse management model is trained via machine learning to determine the predictive analytics; performing, by the one or more processors, simulations of operations of the one or more warehouses based on the one or more predictive analytics to determine one or more warehouse actions to meet one or more operational requirements; and communicating, by the one or more processors, the one or more warehouse actions to one or more devices associated with the one or more warehouses to enable the one or more devices to operate according to the one or more warehouse actions to meet the one or more operational requirements.

In some aspects, the techniques described herein relate to a computing system including: memory; and one or more processors configured to: receive a predictive analytics request associated with one or more warehouses; in response to receiving the predictive analytics request, input data associated with the one or more warehouses into a warehouse management model to determine one or more predictive analytics associated with the one or more warehouses, wherein the warehouse management model is trained via machine learning to determine the predictive analytics; perform simulations of operations of the one or more warehouses based on the one or more predictive analytics to determine one or more warehouse actions to meet one or more operational requirements; and communicate the one or more warehouse actions to one or more devices associated with the one or more warehouses to enable the one or more devices to operate according to the one or more warehouse actions to meet the one or more operational requirements.

In some aspects, the techniques described herein relate to a non-transitory computer-readable medium storing instructions that, when executed by one or more processors of a computing system, cause the one or more processors to: receive a predictive analytics request associated with one or more warehouses; in response to receiving the predictive analytics request, input data associated with the one or more warehouses into a warehouse management model to determine one or more predictive analytics associated with the one or more warehouses, wherein the warehouse management model is trained via machine learning to determine the predictive analytics; perform simulations of operations of the one or more warehouses based on the one or more predictive analytics to determine one or more warehouse actions to meet one or more operational requirements; and communicate the one or more warehouse actions to one or more devices associated with the one or more warehouses to enable the one or more devices to operate according to the one or more warehouse actions to meet the one or more operational requirements.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example environment for artificially intelligent warehouse management, in accordance with aspects of the present disclosure.

FIG. 2 is a flow diagram illustrating operations of the warehouse analytics service of FIG. 1, in accordance with one or more aspects of the present disclosure.

FIG. 3 is a block diagram illustrating further details of an example computing device, in accordance with one or more aspects of the present disclosure.

FIG. 4 illustrates details of an example training system that may perform training of the warehouse management model shown in FIG. 1.

FIG. 5 is a flow diagram illustrating example operations in accordance with one or more aspects of this disclosure.

### DETAILED DESCRIPTION

In general, this disclosure describes techniques for an artificially intelligent warehouse management system that can intelligently manage the operations of a warehouse with or without human interaction. The artificially intelligent warehouse management system may use artificial intelligence, such as machine learning, to optimize warehouse operations and sustainment while providing logistical support for operating the warehouse.

Managing a modern warehouse may involve numerous systems, tools, and conflicts in goals, all in a constantly changing environment. As such, warehouse management may potentially be costly and complex. For example, warehouses may be a constantly changing environment, which may mean that goals and processes may have to be regularly updated and sometimes completely changed. Further, a warehouse manager may have to consider and incorporate changes in the weather and other environmental factors, such as changes to transfer equipment, changes in the types and capabilities of equipment and vehicles used in the warehouses, changes in work patterns, changes in scenarios, and the like, in order to effectively manage a warehouse.

To potentially solve some of the challenges in managing a warehouse, aspects of this disclosure describe an artificially intelligent warehouse management system that may effectively integrate the many moving parts of a modern warehouse to identify changes in processes and procedures to optimize warehouse operation and production. The artificially intelligent warehouse management system may use a machine-trained warehouse management model that is able to predict demand, modify orders, and re-route in-transit goods to warehouses as needed. Such planning and agility in logistics may enable warehouses to provide better service and lower logistics costs. The artificially intelligent warehouse management system may also lower inventory, simplify warehouse management, and enable automation of tasks in the warehouse in ways that improve the speed and accuracy of the warehouses.

In some examples, the artificially intelligent warehouse management system may be used to automatically manage operations of a warehouse with limited or no human supervision. Automating warehouse management and operations may decrease downtime, improve operational speed and adaptability, improve worker safety, and act as a force multiplier on the abilities of warehouse workers and equipment, thereby improving the production and distribution ability of such warehouses.

The artificially intelligent warehouse management system may provide additional technical advantages and improvements. For example, the machine-trained warehouse management model may be implemented in ways that enable the machine-trained warehouse management model to run on a variety of different computing platforms and to integrate into existing warehouse communication systems, warehouse execution systems, and other systems and devices. The artificially intelligent warehouse management system may also provide user-friendly user interfaces that allow users to easily access data produced by the warehouse management model and to modify the warehouse management model. Furthermore, artificially intelligent warehouse management system may also provide application programming interfaces (APIs) that allow decision support software tools written in different languages and running on different computing platforms to programmatically access data produced by the warehouse management model and to modify the warehouse management model, thereby enabling developers to be able to build a wide variety of different software to use and/or access the warehouse management model.

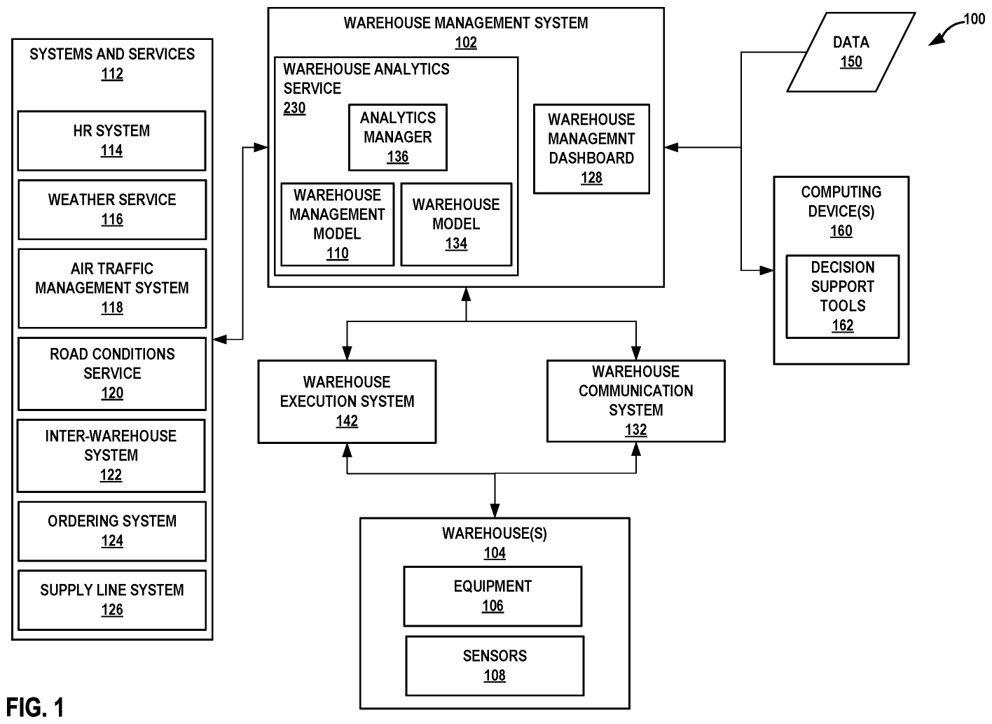

FIG. 1 is a block diagram illustrating an example environment 100 for artificially intelligent warehouse management, in accordance with aspects of the present disclosure. As shown in FIG. 1, environment 100 includes warehouse management system (WMS) 102, warehouse communication system (WCS) 132, and warehouse execution system (WES) 142 that together perform management of one or more warehouses 104.

WCS 132 includes one or more computing devices configured to manage communications within one or more warehouses 104. WCS 132 may manage wired and/or wireless networks and network devices within one or more warehouses 104 to manage and provide voice and data communications within WCS 132. Such communications may include voice communications between workers in or otherwise associated with one or more warehouses 104, data communications to and from the people, equipment 106, and/or sensors 108 associated with one or more warehouses 104, data flows sent from external devices and/or systems to people, computing devices, equipment 106, and/or sensors 108 in one or more warehouses 104, data flows sent from people, computing devices, equipment 106, and/or sensors 108 in one or more warehouses 104 to external devices and systems, and the like.

WES 142 includes one or more computing devices configured to manage and orchestrate the physical flow of goods and materials from receiving through shipping in one or more warehouses 104. WES 142 may manage and direct the execution of processes within one or more warehouses 104, such as physical work processes of workers and/or equipment 106 within one or more warehouses 104. For example, WES 142 may manage and direct execution of automated processes within one or more warehouses 104 performed by equipment 106 as well as manage and direct execution of manual processes within one or more warehouses 104 performed by workers and/or equipment 106.

One or more warehouses 104 may include one or more storage facilities for storing goods and materials received by one or more warehouses 104. In addition to storing goods and materials, one or more warehouses 104 may, in some examples, include additional capabilities, such as the ability to assemble goods and materials, front desk capability to provide customer support, and the like. In some examples, one or more warehouses 104 may be part of or include one or more distribution centers and/or one or more disposition centers. One or more warehouses 104 may act as a distribution center to distribute goods and materials stored at one or more warehouses 104 and/or may act as a disposition center to receive and store goods and materials that are to be disposed. In some examples, one or more warehouses 104 may act as a military warehouse, such as a Defense Logistics Agency (DLA) distribution warehouse. In examples where one or more warehouses 104 act as a military warehouse, one or more warehouses 104 may store military equipment and gear.

One or more warehouses 104 may include equipment 106 that may be used to receive, load, and/or unload goods and materials at one or more warehouses 104, move goods and materials through and/or between one or more warehouses 104, track the goods and materials stored in one or more warehouses 104, and the like. Equipment 106 may include any suitable machinery, equipment, and other mechanical hardware used in one or more warehouses 104, including robots, conveyer belts, pickers, storage and retrieval machinery, and the like. Equipment 106 may also include any suitable vehicles used in one or more warehouses 104, such as forklifts, trucks, robotic vehicles, drones, automatic guided vehicles (AGVs), and the like. Equipment 106 may periodically be updated (e.g., via computerized updates) to improve or otherwise change the capabilities of equipment 106.

One or more warehouses 104 also include sensors 108. Sensors 108 may include any suitable sensors for tracking people, equipment 106, and/or goods and materials in one or more warehouses 104. Examples of sensors 108 may include cameras, microphones, motion sensors, radio-frequency identification (RFID) sensors, Bluetooth Low Energy (BLE) beacons, temperature sensors, open/closed sensors, water detection sensors, occupancy sensors, vehicle count and/or detection sensors, humidity sensors, and the like. While illustrated as being within one or more warehouses 104 in FIG. 1, sensors 108 may also include one or more sensors outside of one or more warehouses 104, such as portable RFID scanners for scanning shipments of goods and equipment that are to be unloaded from trucks.

WMS 102 includes one or more computing devices configured to communicate with any combination of WCS 132, WES 142, sensors 108, and/or equipment 106 to manage and orchestrate the operations of one or more warehouses 104. In some examples, WMS 102 is configured to orchestrate and manage receipt of goods and materials by one or more warehouses 104, orchestrate and manage the organization and storage of goods and materials by one or more warehouses 104, orchestrate and manage retrieval and distribution of goods and materials stored in one or more warehouses 104 that are to be retrieved and dispatched from one or more warehouses 104, manage and orchestrate the use of equipment 106 in one or more warehouses 104, manage and orchestrate the work schedules, tasks, allocation, etc. of workers in one or more warehouses 104, make forecasts regarding future demand of goods and materials from one or more warehouses 104, manage the intake of goods and materials to be stored in one or more warehouses, and the like.

WMS 102 may orchestrate and manage the operations of one or more warehouses 104 in ways that meet key performance indicators (KPIs) associated with one or more warehouses 104. Examples of the KPIs may include inventory accuracy, receiving efficiency, shrinkage, cost of receiving, receiving cycle time, put away accuracy, put away cycle time, picking accuracy, total order cycle time, order lead time, backorder rate, fulfillment accuracy rate, on-time shipping rate, accidents per year, time since last accident, inventory turnover, tailgate-to-stow turnaround time, and any other suitable KPIs.

WMS 102 may face one or more potential challenges to effectively orchestrate and manage the operations of one or more warehouses 104. For instance, one or more warehouses 104 may be a part of a massively complex and interconnected supply chain and logistics system that may be difficult if not impossible for humans to control via WMS 102. As such, outside factors out of the control of one or more warehouses 104, such as changes in weather conditions, changes in road conditions, bottlenecks or disruptions in other parts of the supply chain, may cause issues such as unavoidable delays for one or more warehouses 104 to receive and distribute goods and materials.

WMS 102 may potentially face additional challenges for receiving and storing goods and materials in one or more warehouses 104. For example, not every warehouse in one or more warehouses 104 may be capable of storing goods and materials over a certain size. As such, WMS 102 may have to determine the proper warehouse or warehouses of one or more warehouses 104 for storing certain goods and materials over a certain size that are received by one or more warehouses 104. Further, in examples where one or more warehouses 104 are military warehouses for storing military goods and materials, the goods and materials received by one or more warehouses 104 may have different secrecy classifications, including goods and materials classified as top secret. In these examples, WMS 102 may have to determine the proper warehouse or warehouses of one or more warehouses 104 for storing such top secret goods and materials, as not every warehouse of one or more warehouses 104 may have the necessary security to be able to store top secret goods and materials.

WMS 102 may receive data associated with one or more warehouses 104 and may determine, based on the received data, one or more warehouse actions to be taken in order for the operations of one or more warehouses 104 to meet one or more specified performance standards and/or performance requirements. The data received by WMS 102 may include any combination of logistical data (e.g., component failure rates, shipping times, repair times, maintenance man-hours, and/or warehouse staffing data), historical data, time series data, demand pattern data, warehouse execution data, warehouse communications data, autonomous vehicle data, weather data, road conditions data, human resources data, data generated by equipment 106 in one or more warehouses 104, and/or sensor data generated by sensors 108 in the one or more warehouses 104.

WMS 102 may receive data associated with one or more warehouses 104 from any suitable data source, such as WES 142, WCS 132, equipment 106, sensors 108, as well as from systems and services 112. Systems and services 112 may be any suitable computing devices, computing systems, services, and the like, that may produce data associated with one or more warehouses 104. In some examples, systems and services 112 may include human resources (HR) system 114 that may send data associated with workers at one or more warehouses 104 to WMS 102, and WMS 102 may use the data associated with workers at one or more warehouses 104 to determine work to the workers. For example, HR system 114 may send data to WMS 102 to indicate that a worker is injured or has a medically-assigned light workload and to indicate the type of injury suffered by the worker, medical restrictions of the worker, any limits in mobility or lifting capacity, and the like, so that WMS 102 may assign or otherwise modify the work assigned to the worker.

In some examples, systems and services 112 may also include weather service 116 that may send weather data to WMS 102, including current weather conditions as well as weather forecasts. In some examples, systems and services 112 may also include air traffic management system 118 that may send data regarding flights and flight delays, and road conditions service 120 that may send data regarding road conditions. WMS 102 may use such data from weather service 116, air traffic management system 118, and/or road conditions service 120 to forecast or otherwise predict potential shipping delays of goods and materials to and from one or more warehouses 104, and to determine warehouse actions to be performed to compensate for such delays.

In some examples, systems and services 112 may also include inter-warehouse system 122 that may enable WMS 102 to communicate with other warehouse management systems that manage other warehouses and to exchange data with the other warehouse management systems and the other warehouses. In some examples, systems and services 112 may include ordering system 124 that may send order data to WMS 102 that indicates goods to be shipped from one or more warehouses 104 and deadlines for shipping the goods from one or more warehouses 104. In some examples, systems and services 112 may include a supply line system 126 that may send data to WMS 102 regarding one or more supply lines that one or more warehouses 104 is a part of. The systems and services 112 illustrated in FIG. 1 are just some examples of services and systems that may send data to WMS 102, and WMS 102 may receive data from any other suitable service or system that WMS 102 may use to orchestrate and manage the operations of one or more warehouses 104.

As described above, WMS 102 may determine, based on the data received from WES 142, WCS 132, equipment 106, sensors 108, and/or systems and services 112, one or more actions to take to meet certain performance standards and/or performance requirements. In some examples, the one or more performance standards and/or performance requirements can be specified as key performance indicators (KPIs) associated with the one or more warehouses. Examples of such KPIs may include costs associated with operating one or more warehouses 104, warehouse system downtime, warehouse system availability, inventory accuracy, receiving efficiency, shrinkage, cost of receiving, receiving cycle time, put away accuracy, put away cycle time, picking accuracy, total order cycle time, order lead time, backorder rate, fulfillment accuracy rate, on-time shipping rate, accidents per year, time since last accident, inventory turnover, and any other suitable KPIs.

The performance requirements of one or more warehouses 104, such as specified by the KPIs, may change depending on different scenarios. In the example where one or more warehouses 104 are military warehouses, one or more warehouses 104 may have performance requirements in a peacetime scenario that are different from performance requirements in a wartime scenario. For example, in a wartime scenario, certain KPIs may be more important compared with a peacetime scenario, while other KPIs may be less important compared with a peacetime scenario.

WMS 102 may face potential challenges to effectively manage and orchestrate the operations of one or more warehouses 104. For example, WMS 102 may not be able to determine what goods and materials will be delivered to one or more warehouses 104 until the goods and materials arrive at one or more warehouses 104. WMS 102 may also have to track the goods and materials being stored at one or more warehouses 104 in order to provide asset visibility and to properly distribute goods and materials to destinations.

In another example, if WMS 102 has to modify the work assigned to a worker that is injured, such a modification may have a cascading effect on the operations of one or more warehouses 104, such as affecting the work that has to be assigned to other workers and the work that is to be performed by equipment 106. WMS 102 may have to integrate with WES 142, WCS 132, equipment 106, sensors 108 to change priorities and track progress of work being performed in one or more warehouses 104 and how such work is impacted by the injured worker. WMS 102 may have to balance various trade-offs, such as deciding whether the injured worker is causing additional delay by working instead of just staying home.

Further, WMS 102 may need input from humans or other sources to make decisions having various trade-offs. For example, in a wartime scenario, WMS 102 may have to determine whether to prioritize preventing workers from working overtime (e.g., more than 40 hours a week) in order to minimize warehouse expenditures versus prioritizing shipping out orders in a timely fashion, and may have to determine whether WMS 102 is authorized to approve overtime pay without human approval. WMS 102 may also have to determine the optimal mix of workers and machinery in one or more warehouses 104 to ensure worker safety while not slowing down the work of automated machinery such as automated guided vehicles.

In accordance with aspects of the present disclosure, WMS 102 may include warehouse analytics service 130, which is software that executes at WMS 102 to manage and orchestrate the operations of one or more warehouses 104 and to solve the potential challenges presented above. Specifically, warehouse analytics service 130 may be artificially intelligent software trained via machine learning using a simulated warehouse environment that takes inputs, such as the data described above (e.g., data from systems and services 112) to determine actions to be performed by human workers and/or equipment 106 and/or the organization and/or allocation of people and resources in one or more warehouses 104 to meet the performance requirements for one or more warehouses 104.

A user and/or service may send predictive analytics requests to warehouse analytics service 130 and warehouse analytics service 130 may, in response, use warehouse management model 110 to determine one or more predictive analytics. The one or more predictive analytics may include forecasts regarding goods and materials that are to be delivered to one or more warehouses 104, forecasts regarding the timeframes during which the goods and materials will be delivered to one or more warehouses 104, and/or forecasts of future demand of goods and materials from one or more warehouses 104.

A user and/or service may communicate with WMS 102 to send predictive analytics requests to warehouse analytics service 130 and to receive predictive analytics and/or warehouse actions determined by warehouse analytics service 130. For example, a user such a warehouse supervisor for one or more warehouses 104, may use one or more computing devices 160 to communicate with WMS 102 to send predictive analytics requests to warehouse analytics service 130 and to receive predictive analytics and/or warehouse actions determined by warehouse analytics service 130. Similarly, a service may execute at one or more computing devices 160, WCS 132, and/or WES 142 to send predictive analytics requests to warehouse analytics service 130 and to receive predictive analytics and/or warehouse actions determined by warehouse analytics service 130. In some examples, warehouse analytics service 130 may communicate with equipment 106 to send one or more warehouse actions to equipment 106.

In some examples, warehouse analytics service 130 may be implemented as a platform-agnostic model. That is, warehouse analytics service 130 may be implemented in ways, such as using application programming interfaces (APIs) that enable warehouse analytics service 130 to execute on or to be easily ported to a variety of different computing devices having different processor architectures, different capabilities, different operating systems, and the like.

Warehouse analytics service 130 may include warehouse management model 110, warehouse model 134, and analytics manager 136. Analytics manager 136 may coordinate warehouse management model 110 and warehouse model 134. Analytics manager 136 may also provide a user interface (e.g., a graphical user interface) to enable system administrators of WMS 102 to interact with warehouse analytics service 130. Analytics manager 138 may also interact with warehouse management dashboard 128 to establish data connections with warehouse management dashboard 128 to enable warehouse management dashboard 128 to send and receive data to and from warehouse management model 110 and/or warehouse model 134.

Warehouse management model 110 is an artificially intelligent software trained via machine learning to determine, based at least in part on inputs such as the data described above, forecasts regarding goods and materials that are to be delivered to one or more warehouses 104, forecasts regarding the timeframes during which the goods and materials will be delivered to one or more warehouses 104, and/or forecasts of future demand of goods and materials from one or more warehouses 104.

In some examples, warehouse management model 110 may be able to predict, based on inputs, details of items forecasted to be delivered to one or more warehouses 104, such as item condition, item type, item identity, item owner, item quantity, item source, item destination, and/or time of arrival. Similarly, warehouse management model 110 may be able to predict, based on inputs, details of items forecasted to be demanded (e.g., shipped) from one or more warehouses 104, such as item condition, item type, item identity, item owner, item quantity, item source, item destination, and/or time of demand.

Warehouse management model 110 may be trained to specifically make predictions and forecasts regarding one or more warehouses 104. That is, warehouse management model 110 may be trained using data that may be specific to one or more warehouses 104, such as historical data regarding the operations of one or more warehouses 104, in order to make accurate predictions and forecasts regarding one or more warehouses 104.

For example, warehouse management model 110 may be trained using historical data associated with one or more warehouses 104 that include pairs of due-in item information, which may be information regarding items that are due to be sent to one or more warehouses 104 and receipt information, which may be information regarding items that are actually received by one or more warehouses 104, to forecast, given due-in item information for one or more warehouses 104, the items that one or more warehouses 104 will receive. Such pairs of due-in item information and receipt information may be useful for training warehouse management model 110 because the items actually received by one or more warehouses 104 may not necessarily match the items listed in the corresponding due-in information. In this way, warehouse management model 110 may be trained using historical data associated with one or more warehouses 104 to forecast items that will arrive at one or more warehouses 104.

In addition, warehouse management model 110 may use other historical data associated with one or more warehouses 104 to train warehouse management model 110 to forecast items that will arrive at one or more warehouses 104, such as one or more of: logistical data, historical data, time series data, demand pattern data, warehouse execution data, warehouse communications data, autonomous vehicle data, weather data, road conditions data, human resources data, or sensor data generated by sensors in one or more warehouses 104, where the logistical data may include component failure rates, shipping times, repair times, maintenance man-hours, and/or warehouse staffing data.

In addition, the historical data associated with one or more warehouses 104 used to train warehouse management model 110 may also include KPIs as inputs, such as inventory accuracy, receiving efficiency, shrinkage, cost of receiving, receiving cycle time, put away accuracy, put away cycle time, picking accuracy, total order cycle time, order lead time, backorder rate, fulfillment accuracy rate, on-time shipping rate, accidents per year, time since last accident, inventory turnover, costs associated with running one or more warehouses, warehouse system downtime, warehouse system availability, warehouse data accuracy (e.g., comparisons of orders due at warehouses to when those orders actually arrive at warehouses), and/or any other suitable KPIs.

In some examples, warehouse management model 110 may be trained to operate differently under different scenarios. For example, in a military context where one or more warehouses 104 are under the control of the military, warehouse management model 110 may be trained to operate differently under a peace time scenario compared with a war time scenario. In some examples, warehouse management model 110 may be trained to operate differently in different seasonal scenarios, such as in different months of the year, different days of the year, different quarters of the year, and the like.

Training warehouse management model 110 to operate differently under different scenarios may enable warehouse management model 110 to take into account unique factors that may arise in different scenarios. For example the patterns of items that may arrive at one or more warehouses 104 and/or may be shipped from one or more warehouses 104 may be different in different scenarios.

As such, the historical data associated with one or more warehouses 104 may be categorized into different scenarios, and warehouse management model 110 may be trained for different scenarios using the appropriately categorized scenario. For example, warehouse management model 110 may be trained to operate under a peace time scenario using historical data categorized into the peace time scenario. Such historical data categorized into the peace time scenario may be historical data that occurred during peace time. Similarly, warehouse management model 110 may be trained to operate under a war time scenario using historical data categorized into the war time scenario. Such historical data categorized into the war time scenario may be historical data that occurred during war time (e.g., during a military action, widescale conflict, etc.).

In some examples, warehouse management model 110 may be implemented as one or more neural networks. A neural network, neural network algorithm, or artificial neural network may include a trainable or adaptive algorithm utilizing nodes that define rules. For example, a respective node of a plurality of nodes may utilize a function, such as a non-linear function or if-then rules, to generate an output based on an input. A respective node of the plurality of nodes may be connected to one or more different nodes of the plurality of nodes along an edge, such that the output of the respective node includes the input of the different node. The functions may include parameters that may be determined or adjusted using a training set of inputs and desired outputs, such as, for example, a predetermined association between a plurality of signals or values, such as a blood pressure signal or blood pressure value(s), along with a learning rule, such as a back-propagation learning rule. The back-propagation learning rule may utilize one or more error measurements comparing the desired output to the output produced by the neural network algorithm to train the neural network algorithm by varying the parameters to minimize the one or more error measurements.

An example neural network includes a plurality of nodes, at least some of the nodes having node parameters. An input may be provided (input) to a first node of the neural network algorithm. In some examples, the input may include a plurality of inputs, each input into a respective node. The first node may include a function configured to determine an output based on the input and one or more adjustable node parameters. In some examples, the neural network may include a propagation function configured to determine an input to a subsequent node based on the output of a preceding node and a bias value. In some examples, a learning rule may be configured to modify one or more node parameters to produce a favored output. For example, the favored output may be constrained by one or more threshold values and/or to minimize one or more error measurements. The favored output may include an output of a single node, a set of nodes, or the plurality of nodes.

The neural network algorithm may iteratively modify the node parameters until the output includes the favored output. In this way, warehouse management model 110 may be configured by iteratively evaluating outputs of the neural network algorithm and iteratively modifying at least one of the node parameters based on the evaluation of the outputs of the neural network algorithm to determine one or more outputs, based on the modified neural network algorithm.

In some examples, warehouse management model 110 may be implemented as one or more decision tree-based models. A decision tree-based model uses a supervised learning approach for classification and regression by creating a tree-like model of decisions and their possible consequences to predict the value of a target variable from one or more inputs by following the decisions in the tree, starting from the root node and traversing through the internal nodes and leaf nodes until a prediction is reached. Each internal node in the tree represents a test on an attribute, and each branch represents the outcome of the test. Leaf nodes represent class labels or class probabilities. The tree may be built by starting at the root node and splitting the data into subsets based on the attribute values. This process may be repeated recursively on each subset until the tree is fully grown or until certain stopping criteria are reached. The resulting tree can then be used to make predictions on new data. Decision tree-based models may have the potential advantage of enabling users to interpret the inference process and explain the predictions made by models for a given set of inputs, because the process is a straightforward sequence of branching decisions.

Warehouse analytics service 130 includes warehouse model 134 configured to receive forecasts made by warehouse management model 110 and to determine one or more warehouse actions to be taken to meet such forecasts. That is, warehouse model 134 may receive, from warehouse management model 110, forecasts regarding goods and materials that are to be delivered to one or more warehouses 104, the timeframes during which the goods and materials will be delivered to one or more warehouses 104, and/or future demand of goods and materials from one or more warehouses 104, and may determine, based on such forecasts, one or more warehouse actions to be taken in order for warehouse model 134 to meet one or more operational goals and/or requirements, such as one or more KPIs, to handle such forecasted deliveries and/or demand for goods and materials.

Warehouse model 134 may be trained and/or configured using historical data generated from operating one or more physical warehouses, such as one or more warehouses 104, to act as a digital twin of one or more warehouses 104. In some examples, warehouse model 134 may be an Order Fulfillment Center (OFC) simulation program that simulates key steps in distribution activities to yield recommendations meant to provide operational benefits. Such an OFC simulation program can be built with tools such as the SimPy simulation library, which is a process-based discrete-event simulation framework, and can be implemented as a discrete event simulator with variable parameters to compute step times under different conditions, such as different numbers of personnel, workstations, and equipment, as well as varying types, rates and quantities of orders.

Warehouse model 134 may be configured to simulate the operations of one or more warehouses 104 to determine favorable operation conditions for one or more warehouses 104 based on the predicted forecasts generated by warehouse management model 110. The forecasts generated by warehouse management model 110 may act as operating states for the simulated one or more warehouses, and warehouse model 134 may perform simulations of the operations of one or more warehouses 104 based on such operating states to determine how to operate one or more warehouses 104 in these operating states while meeting one or more operational goals and/or requirements.

In some examples, warehouse model 134 may simulate options for processing forecasted orders, such as by simulating multiple different scenarios and resource allocations for the anticipated orders and workload based on the output of warehouse management model 110. That is, warehouse model 134 may, for orders for one or more warehouses 104 forecasted by warehouse management model 110, provide recommendations for the allocation of resources in the one or more warehouses that yield the highest utilization and lowest operating cost as determined by performance analytics. In this way, warehouse model 134 may enable WMS 102 to estimate the impact of various operating strategies for one or more warehouses 104, such as different resource allocations, for a given set of forecast conditions, thereby enabling WMS 102 to recommend warehouse actions such as resource allocations (e.g., personnel and/or equipment allocations) or other operating decisions based on the predictions of warehouse management model 110.

In some examples, warehouse model 134 may only simulate steps of operating one or more warehouses 104 that are relevant to the portions of order processing involved in the associated operating state determined by warehouse management model 110. For example, if warehouse management model 110 only forecasts items that are to be delivered to one or more warehouses 104 but does not forecast items to be shipped from one or more warehouses 104, warehouse model 134 may only simulate operations of one or more warehouses 104 for unloading, inspecting, and storing items sent to one or more warehouses 104 but may refrain from simulating operations of one or more warehouses 104 for retrieving and shipping items from one or more warehouses 104.

In some examples, warehouse analytics service 130 may, based on the results of warehouse model 134 simulating the operations of one or more warehouses 104 given the operational states produced by warehouse management model 110, determine one or more warehouse actions to be performed to meet one or more operational goals and/or requirements. For example, warehouse analytics service 130 may determine, based on the results of warehouse model 134 simulating the operations of one or more warehouses 104 given the operational states produced by warehouse management model 110, a particular simulated operations of one or more warehouses 104 that meet the one or more operational goals and/or requirements. Warehouse analytics service 130 may therefore determine one or more warehouse actions to be performed at one or more warehouses 104 to modify the current operations of one or more warehouses 104 to correspond to the operations of the particular simulated operations of one or more warehouses 104 that meet the one or more operational goals and/or requirements.

As described above, in the example of FIG. 1, WMS 102 may input data into warehouse analytics service 130 to cause warehouse analytics service 130 to output indications of one or more warehouse actions to be performed in order to meet one or more performance standards (e.g. operational goals and/or requirements), such as KPIs, associated with one or more warehouses 104. WMS 102 may input some or all of the data received by WMS 102 from one or more of WES 142, WCS 132, equipment 106, sensors 108, systems and services 112, or any other devices, services, and systems, into warehouse analytics service 130. In some examples, WMS 102 may transform or otherwise modify data received by WMS 102 prior to inputting the transformed or modified data into warehouse analytics service 130. For example, WMS 102 may change the format of the received data into a different format, remove outlier data, and/or otherwise select subsets of the received data to input into warehouse analytics service 130.

In some examples WMS 102 may also input indications of the one or more performance standards, such as KPIs, associated with one or more warehouses 104 into warehouse analytics service 130. In addition, or alternatively, WMS 102 may also input an indication of one or more scenarios into warehouse analytics service 130, so that warehouse analytics service 130 may determine warehouse actions to be performed based on the inputted data to meet the performance standards associated with different scenarios.

As described above, WMS 102 may use warehouse analytics service 130 to generate one or more warehouse actions to be performed in order to meet one or more performance standards, such as KPIs, associated with one or more warehouses 104. A warehouse action indicates an action to be performed as part of operating and managing one or more warehouses 104. In some examples, a warehouse action may be instructions in human-readable form (e.g., written text, audio, video, etc.) to be viewed by a human (e.g., a worker in one or more warehouses 104), so that the human may perform an action as instructed by the warehouse action. In some examples, a warehouse action may be machine-readable instructions (e.g., code, structured data, unstructured data, a bitstream, application programming interface calls, etc.) sent to a computing device, computing system, a computer-implemented service, equipment 106, autonomous guided vehicles, and the like, so that the device that receives the warehouse action may perform an action according to the warehouse action.

A warehouse action may instruct humans and/or machines and devices to perform any action that is related to managing and orchestrating the operations of one or more warehouses 104. For example, a warehouse action may instruct a human or a device to unload goods from a certain truck, route the unloaded goods to a particular warehouse of one or more warehouses 104, route the goods to a specific section of the particular warehouse for storage, retrieve a specific good from a specific warehouse of one or more warehouses 104 to be dispatched, load the retrieved good onto a specific truck, and the like. A warehouse action may also include instructions for performing other tasks besides dealing with physical goods and materials. For example, A warehouse action may instruct a human or a device to adjust the work schedules of one or more workers of one or more warehouses 104, place a particular order for goods to be delivered to one or more warehouses 104, modify orders placed for goods, re-route goods in-transit to one or more warehouses 104 to other warehouses and/or distribution or disposition centers, and the like.

In some examples, warehouse actions may include allocations of resources in the one or more warehouses, which may be how personnel and equipment are allocated to different warehouses and/or different portions/tasks of one or more warehouses 104 (e.g., receiving bays) throughout a particular time period (e.g., how resources are to be allocated throughout a single day, throughout each day for a week, etc.).

In some examples, warehouse analytics service 130 may identify, based on the data inputted into warehouse analytics service 130, one or more problems in the operations of one or more warehouses 104 and one or more root causes to the one or more problems. These one or more problems in the operations of one or more warehouses 104 may include one or more warehouses 104 not meeting one or more KPIs.

Warehouse model 134 may simulate the operations of one or more warehouses 104 to identify one or more problems in the operations of one or more warehouses 104 and one or more root causes to the one or more problems. For example, warehouse model 134 may perform multiple different simulations of one or more warehouses 104, including performing simulations of one or more warehouses 104 with current operating parameters of one or more warehouses 104 and performing simulations of one or more warehouses 104 with operating parameters different from the current operating parameters of one or more warehouses 104. Warehouse model 134 may therefore determine, based on the simulations, a simulated operations of one or more warehouses 104 with current operating parameters that meet the one or more KPIs. Warehouse model 134 may therefore determine differences in operating parameters between simulated operations of one or more warehouses 104 that meet the one or more KPIs and simulated operations of one or more warehouses 104 with current parameters that do not meet the one or more KPIs. Warehouse model 134 may therefore determine such differences in operating parameters to be the one or more root causes to the one or more problems.

Warehouse analytics service 130 may therefore determine one or more warehouse actions that are corrective actions to fix the one or more root causes to the one or more problems. For example, if warehouse analytics service 130 determines that a root cause to shipping delays by one or more warehouses 104 is some workers having too much work assigned to them, warehouse analytics service 130 may assign warehouse actions to the workers in one or more warehouses 104 in ways that rebalances the workload of the workers.

Warehouse analytics service 130 may determine one or more warehouse actions that are corrective actions to fix the one or more root causes to the one or more problems based at least in part on differences in operating parameters between simulated operations of one or more warehouses 104 that meet the one or more KPIs and simulated operations of one or more warehouses 104 with current parameters that do not meet the one or more KPIs. For example, if the current parameters of one or more warehouses 104 include using fewer workers and assigning more work to each of the workers while the operating parameters of the simulated operations of one or more warehouses 104 that meet the one or more KPIs use more workers that are each assigned less work, warehouse analytics service 130 may assign warehouse actions to the workers in one or more warehouses 104 in ways that rebalances the workload of the workers, such as by distributing work among more workers.

As described above, warehouse management model 110 may, in some examples, output and/or determine a predicted demand forecast associated with one or more warehouses 104, and warehouse analytics service 130 may determine one or more warehouse actions based at least in part on the predicted demand forecast. For example, warehouse management model 110 may predict that the future demand for a particular good stored at one or more warehouses 104 is likely to be significantly higher in the coming weeks. Warehouse analytics service 130 may analyze the current stock of the particular good stored at one or more warehouses 104 and may, in response to determining that the current stock of the particular good stored at one or more warehouses 104 cannot meet the forecasted demand for the particular good, output a warehouse action to order additional inventory of the particular good to be shipped to one or more warehouses 104.

Warehouse analytics service 130 may be integrated with WES 142 and WCS 132 to coordinate with WES 142 and WCS 132 in orchestrating and managing the operations of one or more warehouses 104. The integration of warehouse analytics service 130 with WES 142 and WCS 132 may enable warehouse management model 110 to seamlessly interact with equipment 106, sensors 108, workers, and other devices and systems associated with one or more warehouses 104.

For example, warehouse analytics service 130 may communicate with WES 142 and WCS 132 to exchange data and other information so that warehouse analytics service 130 may receive, from WES 142 and/or WCS 132, data and other information received and/or determined by WES 142 and/or WCS 132 that are associated with one or more warehouses 104. Such data and information may include sensor readings of sensors 108, data inputted by workers into computing devices at one or more warehouses 104 that are communicated from the computing devices to WES 142 and/or WCS 132, data generated by equipment 106 (e.g., error codes, machine data, operational data, etc.) regarding the operations of equipment 106 and/or one or more warehouses 104, data generated by other computing devices in one or more warehouses 104 and communicated to WES 142 and/or WCS 132, and the like. WMS 102 may incorporate such data into the data that is inputted into warehouse analytics service 130 to determine one or mor warehouse actions.

Similarly, warehouse analytics service 130 may send, via WMS 102 to WES 142 and/or WCS 132, data and other information outputted by warehouse analytics service 130 and/or data and other information determined by WMS 102 based on the outputs of warehouse analytics service 130. Such data sent by WMS 102 to WES 142 and/or WCS 132 may include one or more warehouse actions.

When WMS 102 uses warehouse analytics service 130 to generate warehouse actions that are sent to computing devices, systems, equipment 106, and the like, WMS 102 may automate the orchestration and management of the operations of one or more warehouses 104 with little or no human supervision. That is, equipment 106, such as autonomous guided vehicles, autonomous mobile robots, robotic arms, and other autonomous machinery, may receive and autonomously perform the warehouse actions.

As equipment 106 performs the warehouse actions, equipment 106, sensors 108, and other devices within one or more warehouses 104 may track the performance of the warehouse actions as well as any other actions being performed in one or more warehouses 104 and may send data regarding the performance of such actions back to WMS 102, either by directly communicating with WMS 102 via one or more communication links or via WES 142 and/or WCS 132, so that warehouse actions, equipment 106, sensors 108, and other devices within one or more warehouses 104 may report information such as successes or failures at performing the warehouse actions or other suitable status updates. WMS 102 may receive the data regarding the performance of the warehouse actions and may input the received data into warehouse management model 110 to generate, using warehouse model 134, updated warehouse actions that WMS 102 may communicate to WES 142, WCS 132, computing devices, systems, equipment 106, and the like.

In some examples, WMS 102 may include warehouse management dashboard 128 that is configured to provide interfaces, such as dashboard views, through which people (e.g. warehouse site supervisors, auditors, etc.) and/or computing devices may access warehouse analytics service 130 and the data and/or insights generated using warehouse analytics service 130. In some examples, warehouse management dashboard 128 is configured to provide one or more graphical user interfaces (GUIs), such as web interfaces accessible via web browser applications or command line interfaces, that illustrates the data and/or insights regarding one or more warehouses 104 generated using warehouse management model 110 and/or warehouse model 134. The GUIs may include interactive dashboards that provide views regarding the demand forecasted by warehouse management model 110, the warehouse actions determined by warehouse model 134, status information regarding one or more warehouses 104, information regarding the performance of one or more warehouses 104, such as compared to a set of KPIs, problems detected at one or more warehouses 104, and the like.

For example, warehouse management dashboard 128 may provide dashboards that forecast key information about arriving items. In this example, the dashboards may include a visualization of the key parameters for the top ten orders with items anticipated to arrive tomorrow at a particular warehouse, such as the items' forecasted conditions, quantities, sources, and destinations. The visualization of such information may enable the warehouse supervisor to make data-driven planning decisions about resource allocations at the warehouse.

Warehouse management dashboard 128 may generate dashboards that are personalized for users. For example, warehouse management dashboard 128 may enable a user to select the particular predictive analytics information that are presented in the dashboards for the user, the type and/or level of detail of the predictive analytics information presented in the dashboards, and the like. In another example, different types of users, such as auditors, may not find daily forecasts useful, so these users can personalize their dashboards to present current and projected inventory statuses. In some examples, users can also choose to highlight certain conditions in their personalized dashboards, such as order discrepancies, and the users may set notifications to be alerted of important changes in operational status.

In some examples, WMS 102 may provide a set of application programming interfaces (APIs) that enable other applications and services to access the data and/or insights generated using warehouse management model 110 and warehouse model 134. For example, decision support tools 162, which may be software executing at one or more computing devices 160, may call the set of APIs implemented by WMS 102 to access the data and/or insights generated using warehouse management model 110 and warehouse model 134. The set of APIs provided by WMS 102 may allow such decision support tools 162 to send predictive analytics requests to warehouse analytics service 130, receive one or more indications of warehouse actions from warehouse analytics service 130, access information such as the demand forecasted by warehouse management model 110, the warehouse actions determined by warehouse model 134, status information regarding one or more warehouses 104, information regarding the performance of one or more warehouses 104, such as compared to a set of KPIs, problems detected at one or more warehouses 104, and the like.

In some examples, WMS 102 may provide interfaces such as GUIs and APIs that enable users and programs to modify warehouse management model 110. Such interfaces may enable users and programs to input data into warehouse management model 110 and/or modify parameters of warehouse management model 110. Providing GUIs for modifying warehouse management model 110 may enable users without a technical background in programming or machine learning to easily modify warehouse management model 110. Furthermore, providing APIs for modifying warehouse management model 110 may enable applications written in a wide variety of programming languages and executing on a variety of different computing devices, operating systems, processing architectures, and the like to access and modify warehouse management model 110, thereby providing a platform agnostic technique for accessing and modifying warehouse management model 110.

In some examples, WMS 102 may provide interfaces for directly modifying the weights of nodes in the neural network algorithms used by warehouse management model 110, add, remove, or otherwise modify the layers in the neural network algorithms, change the connections between layers of the neural network algorithm, and the like. Similarly, WMS 102 may provide interfaces for inputting data into warehouse management model 110, and warehouse management model 110 may use such inputted data to determine one or more warehouse actions.

In some examples, WMS 102 may be configured to automatically update and retrain warehouse management model 110 as additional operating data of one or more warehouses 104 become available. That is, as one or more warehouses 104 operates, operating data of one or more warehouses 104 may be used as input data to retrain warehouse management model 110 based on the operating data.

In some examples, as an alternative or in addition to enabling users and programs to directly modify the parameters of warehouse management model 110, WMS 102 may provide interfaces such as GUIs and APIs that enable users and programs to modify certain user-facing parameters that correspond to the parameters of warehouse management model 110. For example, WMS 102 may provide interfaces that enable users and programs to adjust the KPIs used by warehouse management model 110, such as by updating the values of specific metrics, increasing or decreasing the importance of meeting certain metrics, adding additional metrics to be met, removing certain metrics, and the like. WMS 102 may also provide interfaces that enable users and programs to manually apply the training methods to update warehouse management model 110 based on novel inputs or new datasets. Similarly, WMS 102 may provide interfaces that enable users and programs to add additional scenarios and associated performance metrics for those scenarios. WMS 102 may map the adjustments to the KPIs to changes in the parameters of warehouse model 134 and/or warehouse management model 110 (e.g., weights, layers, and/or connections within the neural network algorithm) to adjust the parameters of warehouse management model 110 based on the changes made by users and devices via the provided interfaces.

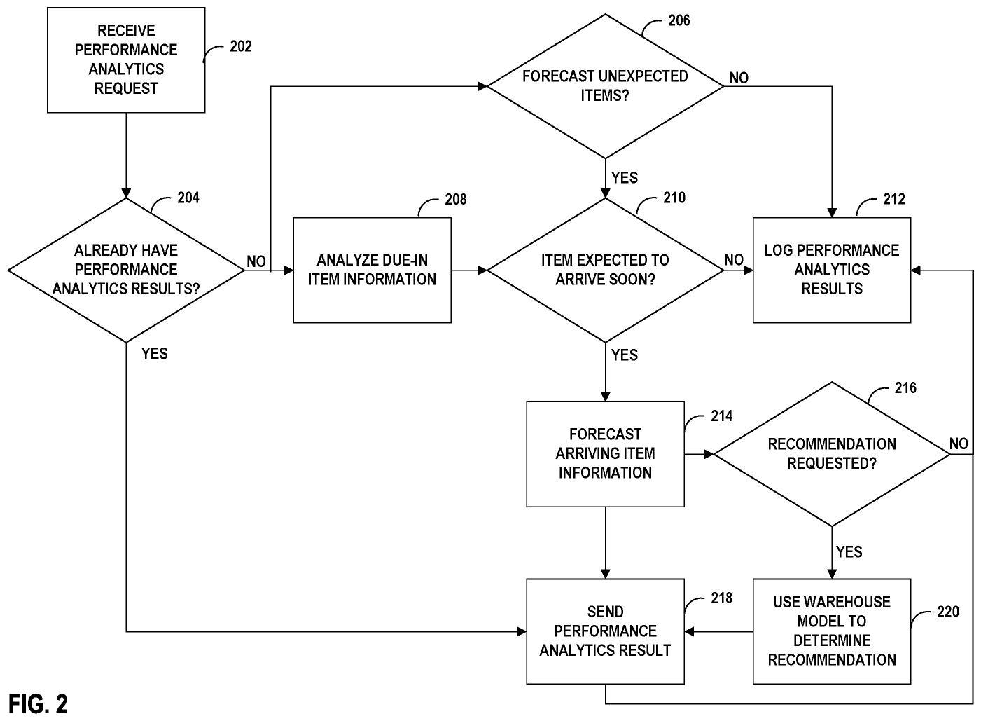

FIG. 2 is a flow diagram illustrating operations of the warehouse analytics service 130 of FIG. 1, in accordance with one or more aspects of the present disclosure. The techniques of FIG. 2 may be performed by one or more processors of a computing device, such as a computing device of WMS 102 of FIG. 1.

As shown in FIG. 2, warehouse analytics service 130 may receive a predictive analytics request (202). The predictive analytics request, in the example of FIG. 2, may be a request for warehouse analytics service 130 to forecast items to be delivered to one or more warehouses 104. The predictive analytics request may be sent, in some examples, by a user using one or more computing devices, such as one or more computing devices 160, one or more services executing on one or more computing device, and the like, and the predictive analytics request may include any suitable information that may be used by warehouse analytics service 130 to perform the forecast of items to be delivered, such as data from services 112. In some examples, such information may include due-in item information, which may be information regarding items that are due to be sent to one or more warehouses 104, which may be in the form of pre-positioned material, items indicated in documents and contracts, bill of lading, a delivery plan, or any other known information regarding items that may be due to be sent to one or more warehouses 104.

Warehouse analytics service 130 may determine, based on the predictive analytics request, whether the predictive analytics results have already been previously determined by warehouse analytics service 130 and logged in WMS 102 (204). For example, warehouse analytics service 130 may log previous predictive analytics requests and may determine whether the received predictive analytics request is the same as a previously-received analytics request. For example, if warehouse analytics service 130 had previously determined, on the same day, predictive analytics results in response to receiving a previous predictive analytics request that contains the same information as the current predictive analytics request (YES at 204), warehouse analytics service 130 may refrain from re-determining the predictive analytics results. Instead, warehouse analytics service 130 may retrieve the previously-determined predictive analytics results and send the previously-determined predictive analytics results to the user or service that requested the predictive analytics results (218), such as by sending the predictive analytics results to the requesting service, presenting the predictive analytics results on a dashboard that can be viewed by the requesting user, sending one or more warehouse actions specified by the predictive analytics results to equipment 106 of one or more warehouses 104, and the like.

If warehouse analytics service 130 determines that the received predictive analytics request is not the same as a previously-received analytics request for which warehouse analytics service 130 has logged predictive analytics results (NO at 204), warehouse analytics service 130 may analyze the due-in information included in the predictive analytics request to determine predictive analytics information regarding the items listed in the due-in information (208). As described above, due-in information may be information regarding items that are known to be scheduled to be sent to one or more warehouses 104 during a given time period, such as during a given month of the year, during a given quarter of the year, and the like.

Warehouse management model 110 may receive the information included in the predictive analytics request and may determine, based at least in part on the information included in the predictive analytics request, a forecast of items to be delivered to one or more warehouses 104 (208). The forecast of items to be delivered to one or more warehouses 104 may indicate the predicted items to be delivered to one or more warehouses 104 and details of the items, such as item condition, item type, item identity, item owner, item quantity, item source, item destination, and/or time of arrival.

In some examples, the due-in item information may, for an item, indicate when (e.g., date and/or time) the item is scheduled to arrive at one or more warehouses 104. Warehouse analytics service 130 may therefore determine, for each item listed in the due-in item information, whether the item is expected to arrive soon, such as today (e.g., within 24 hours), tomorrow (within 24-48 hours), and the like, at one or more warehouses 104 (210).

In some examples, warehouse analytics service 130 may determine whether to forecast unexpected items that may arrive at one or more warehouses 104 (206). Such unexpected items may be items that arrive at one or more warehouses 104 without being listed in the due-in item information. In some examples, the predictive analytics request received by warehouse analytics service 130 may indicate whether the predictive analytics determined by warehouse analytics service 130 is to include a forecast of unexpected items that may arrive at one or more warehouses 104. As such, warehouse analytics service 130 may determine whether to forecast unexpected items that may arrive at one or more warehouses 104 based on the received predictive analytics request.

If warehouse analytics service 130 determines not to forecast unexpected items that may arrive at one or more warehouses 104 (NO at 206), warehouse analytics service 130 may refrain from forecasting unexpected items and may instead log an indication that the predictive analytics request did not involve a forecast of unexpected items that may arrive at one or more warehouses 104. If warehouse analytics service 130 determines to forecast unexpected items that may arrive at one or more warehouses 104, warehouse management model 110 may also determine item information regarding one or more unexpected items that may arrive at one or more warehouses, such as the time and/or date the one or more unexpected items are predicted to arrive at one or more warehouses 104, such as to determine whether such unexpected items are predicted to arrive soon to one or more warehouses 104 (210).

How soon items are scheduled to arrive may determine whether entities of one or more warehouses 104 may have to immediately take one or more warehouse actions to ensure that one or more warehouses 104 may meet one or more performance standards (e.g. operational goals and/or requirements), such as KPIs, to take delivery of such items. For example, if some items are not scheduled to arrive until a week later, it may not be necessary for one or more warehouses 104 to immediately take one or more warehouse actions to take delivery of such items.

As such, warehouse analytics service 130 may determine, for each item listed in the due-in item information, whether the item is scheduled in the due-in item information. If a due-in item are not expected to arrive soon, such as within 24 hours, within 48 hours, and the like (NO at 210), warehouse analytics service 130 may merely log any predictive analytics results associated with the due-in item (212).

Warehouse management model 110 may, for items listed in the due-in item information that are expected to arrive soon, such as within 24 hours, within 48 hours, and the like as well as for unexpected items that are forecasted to arrive soon to one or more warehouses 104 (YES at 210), forecast arriving item information for those items (214). Although the due-in item information for these items may indicate a scheduled arrival time and/or date for these items, the items may not actually arrive at the scheduled arrival time and/or date. As such, warehouse management model 110 may forecast the arrival time and/or date for each of these items. Warehouse management model 110 may also forecast other details of the items, such as item condition, item type, item identity, item owner, item quantity, item source, item destination, and the like.

In some examples, warehouse analytics service 130 may also determine whether the predictive analytics request includes a request for recommendations of warehouse actions for meeting one or more performance standards (216). If the predictive analytics request does not include a request for recommendations of warehouse actions (NO at 216), warehouse analytics service 130 may log any predictive analytics results (212).

If the predictive analytics request includes a request for recommendations of warehouse actions (YES at 216), warehouse model 134 may simulate the performance of one or more warehouses 104 given operational parameters of receiving the items that are forecasted to arrive soon as determined by warehouse management model 110 to determine one or more warehouse actions to take for one or more warehouses 104 to meet operational standards (220). For example, warehouse model 134 may determine, given the operational parameters of receiving the items that are forecasted to arrive soon as determined by warehouse management model 110, resource allocations of one or more warehouses 104, human allocations of one or more warehouses 104, and the like to meet operational standards.

Warehouse analytics service 130 may therefore send the one or more warehouse actions to take for one or more warehouse 104 to the user or service that requested the predictive analytics results (218), such as by sending information regarding the one or more warehouse actions to the requesting service, presenting information regarding the one or more warehouse actions on a dashboard that can be viewed by the requesting user, sending the one or more warehouse actions specified by the predictive analytics results to equipment 106 of one or more warehouses 104, and the like. Warehouse analytics service 130 may also log the one or more warehouse actions to take for one or more warehouse 104 (212).

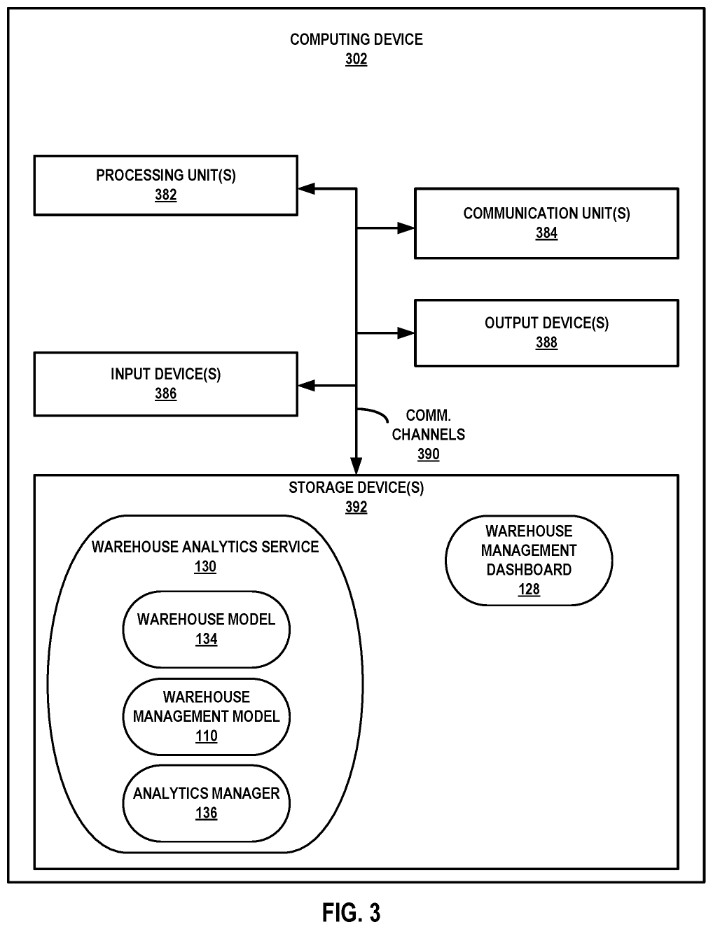

FIG. 3 is a block diagram illustrating further details of an example computing device, in accordance with one or more aspects of the present disclosure. FIG. 3 illustrates only one particular example of computing device 302, and many other examples of computing device 302 may be used in other instances and may include a subset of the components shown, or may include additional components not shown, in FIG. 3.

As shown in the example of FIG. 3, computing device 302 includes one or more processing units 382, one or more input devices 386, one or more communication units 384, one or more output devices 388, and one or more storage devices 392. Storage devices 392 may include warehouse management dashboard 128, warehouse analytics service 130, warehouse management model 110, and warehouse model 134. Communication channels 390 may interconnect each of the components 382, 384, 386, 388, and 392 for inter-component communications (physically, communicatively, and/or operatively). In some examples, communication channels 390 may include a system bus, a network connection, an inter-process communication data structure, or any other method for communicating data between hardware and/or software.

One or more input devices 386 of computing device 302 may receive input. Examples of input are tactile, audio, and video input. Examples of input devices 386 include a presence-sensitive screen, touch-sensitive screen, mouse, keyboard, voice responsive system, video camera, microphone or any other type of device for detecting input from a human or machine.

One or more output devices 388 of computing device 302 may generate output. Examples of output are tactile, audio, and video output. Examples of output devices 388 include a presence-sensitive screen, sound card, video graphics adapter card, speaker, liquid crystal display (LCD), or any other type of device for generating tactile, audio, and/or visual output to a human or machine.

One or more communication units 384 of computing device 302 may communicate with one or more other computing systems or devices (e.g., WCS 132, WES 142, one or more computing devices 160, sensors 108, equipment 106, and systems and services 112 shown in FIG. 1) via one or more networks by transmitting and/or receiving network signals on the one or more networks. Examples of communication units 384 include a network interface card (e.g., such as an Ethernet card), an optical transceiver, a radio frequency transceiver, or any other type of device that can send and/or receive information, such as through a wired or wireless network. Other examples of communication units 384 may include short wave radios, cellular data radios, wireless Ethernet network radios, as well as universal serial bus (USB) controllers.

One or more storage devices 392 within computing device 302 may store information for processing during operation of computing device 302 (e.g., computing device 302 may store data accessed by one or more modules, processes, applications, or the like during execution at computing device 302). In some examples, storage devices 392 on computing device 302 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art. In some cases, storage devices 392 may include redundant array of independent disks (RAID) configurations and one or more solid-state drives (S SD's).

Storage devices 392, in some examples, also include one or more computer-readable storage media. Storage devices 392 may be configured to store larger amounts of information than volatile memory. Storage devices 392 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 392 may store program instructions and/or data associated with one or more software/firmware elements or modules.

Computing device 302 further includes one or more processing units 382 that may implement functionality and/or execute instructions within computing device 302. For example, processing units 382 may receive and execute instructions stored by storage devices 392 that execute the functionality of the elements and/or modules described herein, such as the functionalities of warehouse management dashboard 128, warehouse analytics service 130, warehouse management model 110, and warehouse model 134. These instructions executed by processing units 382 may cause computing device 302 to store information within storage devices 392 during program execution. Processing units 382 may also execute instructions of an operating system to perform one or more operations described herein.

Storage devices 392 may store software that may be executed by one or more processing units 382, such as warehouse analytics service 130, warehouse management model 110, warehouse model 134, analytics manager 136, and warehouse management dashboard 128. One or more processing units 382 are configured to execute warehouse management dashboard 128, warehouse analytics service 130, warehouse management model 110, and warehouse model 134 to perform any of the described techniques of this disclosure.

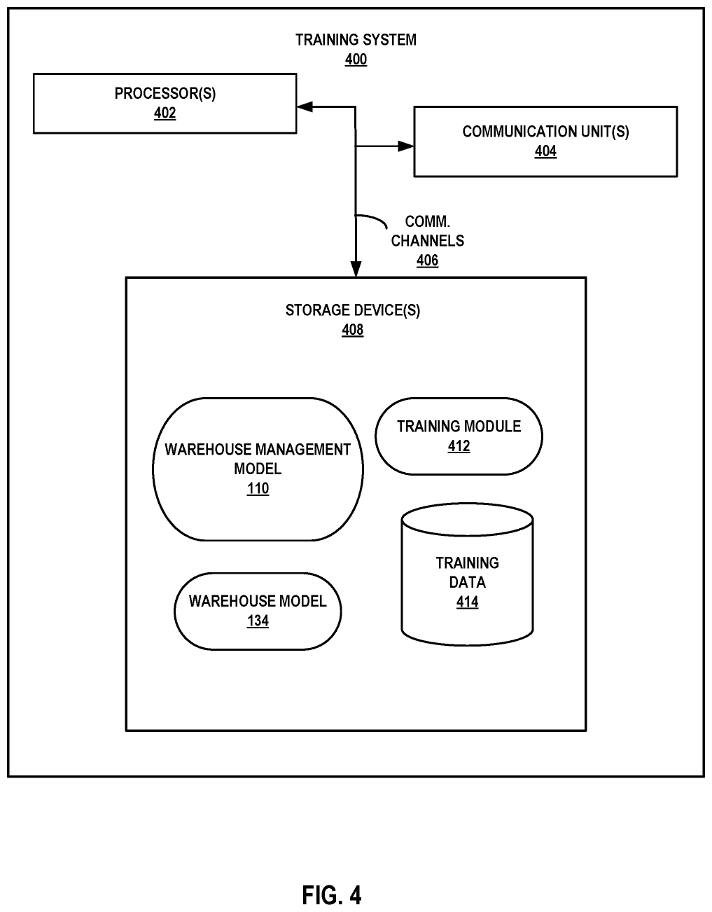

FIG. 4 illustrates details of an example training system 400 that may perform training of warehouse management model 110 and warehouse model 134 shown in FIG. 1. FIG. 4 illustrates only one particular example of training system 400, and many other example devices having more, fewer, or different components may also be configurable to perform operations in accordance with techniques of the present disclosure.

While displayed as part of a single device in the example of FIG. 4, components of training system 400 may, in some examples, be located within and/or be a part of different devices. For instance, in some examples, training system 400 may represent a “cloud” computing system. Thus, in these examples, the modules illustrated in FIG. 4 may span across multiple computing devices. In some examples, training system 400 may represent one of a plurality of servers making up a server cluster for a “cloud” computing system. In other examples, training system 400 may be an example of WMS 102 shown in FIG. 1.

As shown in the example of FIG. 4, training system 400 includes one or more processors 402, one or more communications units 404, and one or more storage devices 408. Storage devices 408 further include warehouse management model 110, training module 412, and training data 414. Each of components 402, 404, and 408 may be interconnected (physically, communicatively, and/or operatively) for inter-component communications. In the example of FIG. 4, components 402, 404, and 408 may be coupled by one or more communications channels 406. In some examples, communications channels 406 may include a system bus, network connection, inter-process communication data structure, or any other channel for communicating data. Warehouse management model 110, training module 412, and training data 414 may also communicate information with one another as well as with other components in training system 400.

In the example of FIG. 4, one or more processors 402 (each including processing circuitry) may implement functionality and/or execute instructions within training system 400. For example, one or more processors 402 may receive and execute instructions stored by storage devices 408 that execute the functionality of training module 412. These instructions executed by one or more processors 402 may cause training system 400 to store information within storage devices 408 during execution. One or more processors 402 may execute instructions of training module 412 to train warehouse management model 110 using training data 414. That is, training module 412 may be operable by one or more processors 402 to perform various actions or functions of training system 400 described herein.

In the example of FIG. 4, one or more communication units 404 may be operable to communicate with external devices (e.g., WMS 102 of FIG. 1) via one or more networks by transmitting and/or receiving network signals on the one or more networks. For example, training system 400 may use communication units 404 to transmit and/or receive radio signals on a radio network such as a cellular radio network. Likewise, communication units 404 may transmit and/or receive satellite signals on a satellite network such as a global positioning system (GPS) network. Examples of communication units 404 include a network interface card (e.g., such as an Ethernet card), an optical transceiver, a radio frequency transceiver, or any other type of device that can send and/or receive information. Other examples of communication units 404 may include Near-Field Communications (NFC) units, Bluetooth® radios, short wave radios, cellular data radios, wireless network (e.g., Wi-Fi®) radios, as well as universal serial bus (USB) controllers.

One or more storage devices 408 may be operable, in the example of FIG. 4, to store information for processing during operation of training system 400. In some examples, storage devices 408 may represent temporary memory, meaning that a primary purpose of storage devices 408 is not long-term storage. For instance, storage devices 408 of training system 400 may be volatile memory, configured for short-term storage of information, and therefore not retain stored contents if powered off. Examples of volatile memories include random access memories (RAM), dynamic random access memories (DRAM), static random access memories (SRAM), and other forms of volatile memories known in the art.

Storage devices 408, in some examples, also represent one or more computer-readable storage media. That is, storage devices 408 may be configured to store larger amounts of information than a temporary memory. For instance, storage devices 408 may include non-volatile memory that retains information through power on/off cycles. Examples of non-volatile memories include magnetic hard discs, optical discs, floppy discs, flash memories, or forms of electrically programmable memories (EPROM) or electrically erasable and programmable (EEPROM) memories. In any case, storage devices 408 may, in the example of FIG. 4, store program instructions and/or data associated with warehouse management model 110, training module 412, and training data 414.

One or more processors 402 may, in the example of FIG. 4, execute training module 412 to train warehouse management model 110 using training data 414 to more accurately and/or more quickly make forecasts regarding goods and materials that are to be delivered to one or more warehouses 104, forecasts regarding the timeframes during which the goods and materials will be delivered to one or more warehouses 104, and/or forecasts of future demand of goods and materials from one or more warehouses 104. Such forecasts made by warehouse management model 110 may also be referred to herein as predictive analytics.

For example, training module 412 main train warehouse management model 110 using training data 414 to predict, based on inputs, details of items forecasted to be delivered to one or more warehouses 104, such as item condition, item type, item identity, item owner, item quantity, item source, item destination, and/or time of arrival. Similarly, warehouse management model 110 may be able to predict, based on inputs, details of items forecasted to be demanded (e.g., shipped) from one or more warehouses 104, such as item condition, item type, item identity, item owner, item quantity, item source, item destination, and/or time of demand.

Warehouse management model 110 may include a deep learning architecture such as a recurrent neural network, convolutional neural network, one or more decision trees, and the like that includes multiple layers to progressively extract higher level features from inputs to warehouse management model 110.

Warehouse management model 110 may be trained to specifically make predictions and forecasts regarding one or more warehouses 104. That is, warehouse management model 110 may be trained using data that may be specific to one or more warehouses 104, such as historical data regarding the operations of one or more warehouses 104, in order to make accurate predictions and forecasts regarding one or more warehouses 104.

For example, warehouse management model 110 may be trained using historical data associated with one or more warehouses 104 that include pairs of due-in item information, which may be information regarding items that are due to be sent to one or more warehouses 104 and receipt information, which may be information regarding items that are actually received by one or more warehouses 104, to forecast, given due-in item information for one or more warehouses 104, the items that one or more warehouses 104 will receive. Such pairs of due-in item information and receipt information may be useful for training warehouse management model 110 because the items actually received by one or more warehouses 104 may not necessarily match the items listed in the corresponding due-in information. In this way, warehouse management model 110 may be trained using historical data associated with one or more warehouses 104 to forecast items that will arrive at one or more warehouses 104.

In addition, warehouse management model 110 may use other historical data associated with one or more warehouses 104 to train warehouse management model 110 to forecast items that will arrive at one or more warehouses 104, such as one or more of: logistical data, historical data, time series data, demand pattern data, warehouse execution data, warehouse communications data, autonomous vehicle data, weather data, road conditions data, human resources data, or sensor data generated by sensors in one or more warehouses 104, where the logistical data may include component failure rates, shipping times, repair times, maintenance man-hours, and/or warehouse staffing data.

In addition, the historical data associated with one or more warehouses 104 used to train warehouse management model 110 may also include KPIs as inputs, such as inventory accuracy, receiving efficiency, shrinkage, cost of receiving, receiving cycle time, put away accuracy, put away cycle time, picking accuracy, total order cycle time, order lead time, backorder rate, fulfillment accuracy rate, on-time shipping rate, accidents per year, time since last accident, inventory turnover, costs associated with running one or more warehouses, warehouse system downtime, warehouse system availability, warehouse data accuracy (e.g., comparisons of orders due at warehouses to when those orders actually arrive at warehouses), and/or any other suitable KPIs.

In some examples, training module 412 may train warehouse management model 110 to operate differently under different scenarios. For example, in a military context where one or more warehouses 104 are under the control of the military, warehouse management model 110 may be trained to operate differently under a peace time scenario compared with a war time scenario. In some examples, training module 412 may train warehouse management model 110 to operate differently in different seasonal scenarios, such as in different months of the year, different days of the year, different quarters of the year, and the like. Training warehouse management model 110 to operate differently under different scenarios may enable warehouse management model 110 to take into account unique factors that may arise in different scenarios. For example the patterns of items that may arrive at one or more warehouses 104 and/or may be shipped from one or more warehouses 104 may be different in different scenarios.

As such, training system 400 may categorize training data 414 into different scenarios, and training module 412 may train warehouse management model 110 for different scenarios using the appropriately categorized scenario. For example, training module 412 may train warehouse management model 110 to operate under a peace time scenario using historical data categorized into the peace time scenario as training data 414. Such historical data categorized into the peace time scenario may be historical data that occurred during peace time. Similarly, training module 412 may train warehouse management model 110 to operate under a war time scenario using historical data categorized into the war time scenario as training data 414. Such historical data categorized into the war time scenario may be historical data that occurred during war time (e.g., during a military action, widescale conflict, etc.).

In some examples, once training module 412 has trained warehouse management model 110 using training data 414, training module 412 may test warehouse management model 110 by using a set of test data not yet encountered by using warehouse management model 110 to determine how closely the warehouse actions outputted by warehouse management model 110 based on the test data matches the expected warehouse actions to be performed based on the test data. In this way, training module 412 may evaluate and further refine warehouse management model 110.

When training module 412 has completed training of warehouse management model 110, warehouse management model 110 can be installed, uploaded, or otherwise transferred to WMS 102. In some examples, one or more processors 402 may execute training module 412 to upload or otherwise transfer a copy of warehouse management model 110 to another server or to the cloud, and WMS 102 may receive warehouse management model 110 via a network such as the Internet, a virtual private network, a local area network, and the like.

As warehouse management model 110 operates at WMS 102, training system 400 may be configured to retrain warehouse management model 110 based on data associated with the performance of warehouse management model 110. That is, training module 412 may receive (e.g., from WMS 102) data forecasted by warehouse management model 110 while executing at WMS 102 and the corresponding real-world data, and may retrain warehouse management model 110 to minimize differences between data forecasted by warehouse management model 110 and the corresponding real-world data.

For example, training module 412 may receive data regarding items forecasted by warehouse management model 110 to be delivered to one or more warehouses 104 during a specific time period, including details of items forecasted to be delivered, such as item condition, item type, item identity, item owner, item quantity, item source, item destination, and/or time of arrival. Training module 412 may also receive data regarding items actually delivered to one or more warehouses 104 during the specific time period, including details of the delivered items, as well as any other data associated with the delivery of such items during the specific time period, such as logistical data, historical data, time series data, demand pattern data, warehouse execution data, warehouse communications data, autonomous vehicle data, weather data, road conditions data, human resources data, or sensor data generated by sensors in the one or more warehouses, where the logistical data may include component failure rates, shipping times, repair times, maintenance man-hours, and/or warehouse staffing data. Training module 412 may therefore retrain warehouse management model 110 to minimize differences between the forecasted items to be delivered and the actual items that were delivered.

In some examples, training module 412 may also perform training and/or configuration of warehouse model 134. As described throughout this disclosure, warehouse model 134 may be software that executes at WMS 102 to digitally simulate and model the operations of one or more warehouses 104.

In some examples, training module 412 may use historical data generated from operating one or more warehouses 104 to generate a digital twin of one or more warehouses 104. Such historical data may include the historical operational parameters of one or more warehouses 104, historical resource allocations of one or more warehouses 104, historical KPIs of one or more warehouses 104, and the like. In some examples, training module 412 may use any other data associated with historical operations of one or more warehouses 104 to train warehouse model 134, such as logistical data, time series data, demand pattern data, warehouse execution data, warehouse communications data, autonomous vehicle data, weather data, road conditions data, human resources data, or sensor data generated by sensors in the one or more warehouses, where the logistical data may include component failure rates, shipping times, repair times, maintenance man-hours, and/or warehouse staffing data. In this way, training module 412 may train warehouse model 134 to, given a set of operational parameters, simulate operations of one or more warehouses 104 to determine the performance of one or more warehouses 104 and to determine whether the performance of specific configurations and/or operations of one or more warehouses 104 meets operational goals.

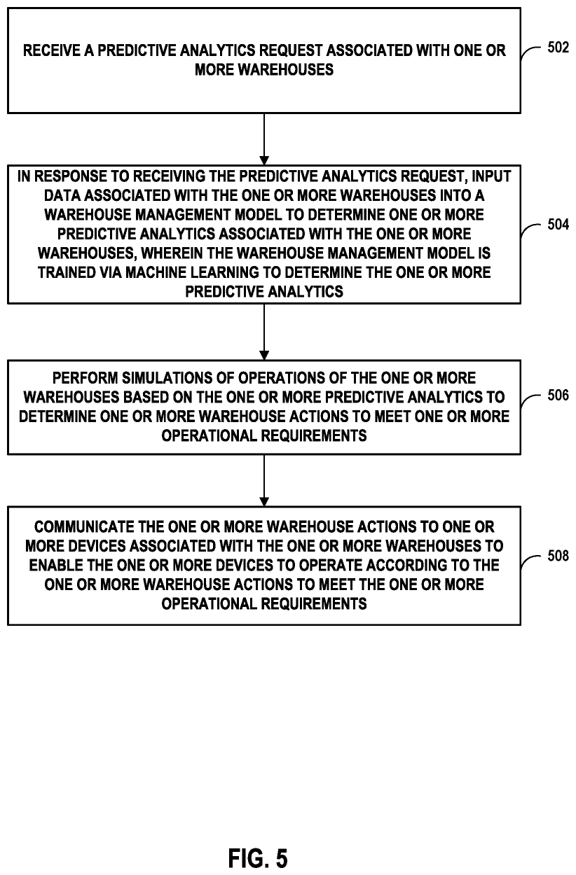

FIG. 5 is a flow diagram illustrating example operations of a warehouse management system, in accordance with one or more aspects of this disclosure. The techniques of FIG. 5 may be performed by one or more processors of a computing device, such as a computing device of WMS 102 of FIG. 1.

As shown in FIG. 5, one or more processors of WMS 102 may receive a predictive analytics request associated with one or more warehouses 104 (502). One or more processors of WMS 102 may, in response to receiving the predictive analytics request, input data associated with the one or more warehouses 104 into a warehouse management model 110 to determine one or more predictive analytics associated with the one or more warehouses 104, wherein the warehouse management model is trained via machine learning to determine the predictive analytics (504). One or more processors of WMS 102 may perform simulations of operations of the one or more warehouses 104 based on the one or more predictive analytics to determine one or more warehouse actions to meet one or more operational requirements (506). One or more processors of WMS 102 may communicate the one or more warehouse actions to one or more devices associated with the one or more warehouses to enable the one or more devices to operate according to the one or more warehouse actions to meet the one or more operational requirements (508).

In some examples, the one or more predictive analytics associated with the one or more warehouses 104 include at least one of: a predicted demand forecast for the one or more warehouses 104 or a predicted arriving items forecast for the one or more warehouses 104. In some examples, the predicted arriving items forecast for the one or more warehouses 104 include indications of items forecasted to be delivered to the one or more warehouses 104 for a specified time period and indications of one or more details of each of the items forecasted to be delivered to the one or more warehouses 104. In some examples, the one or more details of each of the items forecasted to be delivered to the one or more warehouses 104 include an item condition. In some examples, the predicted demand forecast for the one or more warehouses 104 include indications of items forecasted to be demanded from the one or more warehouses 104 for a specified time period and indications of one or more details of each of the items forecasted to be demanded from the one or more warehouses 104.

In some examples, to perform the simulations of operations of the one or more warehouses 104 based on the one or more predictive analytics to determine the one or more warehouse actions to meet the one or more operational requirements, the one or more processors of WMS 102 may further perform the simulations of operations of the one or more warehouses 104 based on the one or more predictive analytics to determine one or more root causes of the one or more warehouses 104 not meeting the one or more operational requirements and determine the one or more warehouse actions to be performed to meet the one or more operational requirements.

In some examples, to determine the one or more warehouse actions to be performed to meet the one or more operational parameters, one or more processors of WMS 102 may determine current operating parameters of the one or more warehouses, determine operating parameters of a simulation of operations of the one or more warehouses 104 that meets the one or more operational requirements out of the simulations of operations of the one or more warehouses 104, and determine the one or more warehouse actions to be performed to meet the one or more operational requirements based at least in part on one or more differences between the current operating parameters of the one or more warehouses 104 and the operating parameters of the simulation of operations of the one or more warehouses 104 that meets the one or more operational requirements.

In some examples, the warehouse management model 110 is trained to operate differently in a plurality of different scenarios, and wherein to input the data associated with the one or more warehouses 104 into the warehouse management model to determine the one or more predictive analytics associated with the one or more warehouses 104, the one or more processors of WMS 102 may input the data associated with the one or more warehouses into the warehouse management model 110 operating in a particular scenario out of the plurality of different scenarios to determine the one or more predictive analytics associated with the one or more warehouses 104.

In some examples, the plurality of different scenarios include a peace time scenario and a wartime scenario.

In some examples, the data associated with the one or more warehouses 104 include one or more of: logistical data, historical data, time series data, demand pattern data, warehouse execution data, warehouse communications data, autonomous vehicle data, weather data, road conditions data, human resources data, sensor data generated by sensors in the one or more warehouses, ordering data, purchasing data, shipping data, or air traffic data.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the embodiment, certain acts or events of any of the methods described herein can be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium may include a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

What is claimed is:

1. A method comprising:
receiving, by one or more processors of a warehouse management system, a predictive analytics request associated with one or more warehouses;
in response to receiving the predictive analytics request, inputting, by the one or more processors, data associated with the one or more warehouses into a warehouse management model to determine one or more predictive analytics associated with the one or more warehouses, wherein the warehouse management model is trained via machine learning to determine the one or more predictive analytics;
performing, by the one or more processors, simulations of operations of the one or more warehouses based on the one or more predictive analytics to determine one or more warehouse actions to meet one or more operational requirements; and
communicating, by the one or more processors, the one or more warehouse actions to one or more devices associated with the one or more warehouses to enable the one or more devices to operate according to the one or more warehouse actions to meet the one or more operational requirements.

2. The method of claim 1, wherein the one or more predictive analytics associated with the one or more warehouses include at least one of: a predicted demand forecast for the one or more warehouses or a predicted arriving items forecast for the one or more warehouses.

3. The method of claim 2, wherein the predicted arriving items forecast for the one or more warehouses include indications of items forecasted to be delivered to the one or more warehouses for a specified time period and indications of one or more details of each of the items forecasted to be delivered to the one or more warehouses.

4. The method of claim 3, wherein the one or more details of each of the items forecasted to be delivered to the one or more warehouses include an item condition.

5. The method of claim 2, wherein the predicted demand forecast for the one or more warehouses include indications of items forecasted to be demanded from the one or more warehouses for a specified time period and indications of one or more details of each of the items forecasted to be demanded from the one or more warehouses.

6. The method of claim 1, wherein performing the simulations of operations of the one or more warehouses based on the one or more predictive analytics to determine the one or more warehouse actions to meet the one or more operational requirements further comprises:
performing, by the one or more processors, the simulations of operations of the one or more warehouses based on the one or more predictive analytics to determine one or more root causes of the one or more warehouses not meeting the one or more operational requirements; and
determining, by the one or more processors, the one or more warehouse actions to be performed to meet the one or more operational requirements.

7. The method of claim 6, wherein determining the one or more warehouse actions to be performed to meet the one or more operational requirements further comprises:
determining, by the one or more processors, current operating parameters of the one or more warehouses;
determining, by the one or more processors, operating parameters of a simulation of operations of the one or more warehouses that meets the one or more operational requirements out of the simulations of operations of the one or more warehouses; and
determining, by the one or more processors, the one or more warehouse actions to be performed to meet the one or more operational requirements based at least in part on one or more differences between the current operating parameters of the one or more warehouses and the operating parameters of the simulation of operations of the one or more warehouses that meets the one or more operational requirements.

8. The method of claim 1, wherein the warehouse management model is trained to operate differently in a plurality of different scenarios, and wherein inputting the data associated with the one or more warehouses into the warehouse management model to determine the one or more predictive analytics associated with the one or more warehouses further comprises:
inputting, by the one or more processors, the data associated with the one or more warehouses into the warehouse management model operating in a particular scenario out of the plurality of different scenarios to determine the one or more predictive analytics associated with the one or more warehouses.

9. The method of claim 8, wherein the plurality of different scenarios include a peace time scenario and a wartime scenario.

10. The method of claim 1, wherein the data associated with the one or more warehouses include one or more of: logistical data, historical data, time series data, demand pattern data, warehouse execution data, warehouse communications data, autonomous vehicle data, weather data, road conditions data, human resources data, sensor data generated by sensors in the one or more warehouses, ordering data, purchasing data, shipping data, or air traffic data.

11. A computing system comprising:
memory; and
one or more processors configured to:
receive a predictive analytics request associated with one or more warehouses;
in response to receiving the predictive analytics request, input data associated with the one or more warehouses into a warehouse management model to determine one or more predictive analytics associated with the one or more warehouses, wherein the warehouse management model is trained via machine learning to determine the one or more predictive analytics;
perform simulations of operations of the one or more warehouses based on the one or more predictive analytics to determine one or more warehouse actions to meet one or more operational requirements; and
communicate the one or more warehouse actions to one or more devices associated with the one or more warehouses to enable the one or more devices to operate according to the one or more warehouse actions to meet the one or more operational requirements.

12. The computing system of claim 11, wherein the one or more predictive analytics associated with the one or more warehouses include at least one of:
a predicted demand forecast for the one or more warehouses or a predicted arriving items forecast for the one or more warehouses.

13. The computing system of claim 12, wherein the predicted arriving items forecast for the one or more warehouses include indications of items forecasted to be delivered to the one or more warehouses for a specified time period and indications of one or more details of each of the items forecasted to be delivered to the one or more warehouses.

14. The computing system of claim 13, wherein the one or more details of each of the items forecasted to be delivered to the one or more warehouses include an item condition.

15. The computing system of claim 12, wherein the predicted demand forecast for the one or more warehouses include indications of items forecasted to be demanded from the one or more warehouses for a specified time period and indications of one or more details of each of the items forecasted to be demanded from the one or more warehouses.

16. The computing system of claim 11, wherein to perform the simulations of operations of the one or more warehouses based on the one or more predictive analytics to determine the one or more warehouse actions to meet the one or more operational requirements, the one or more processors are further configured to:
perform the simulations of operations of the one or more warehouses based on the one or more predictive analytics to determine one or more root causes of the one or more warehouses not meeting the one or more operational requirements and determining the one or more warehouse actions to be performed to meet the one or more operational requirements.

17. The computing system of claim 16, wherein to determine the one or more warehouse actions to be performed to meet the one or more operational requirements, the one or more processors are further configured to:
determine current operating parameters of the one or more warehouses;
determine operating parameters of a simulation of operations of the one or more warehouses that meets the one or more operational requirements out of the simulations of operations of the one or more warehouses; and
determine the one or more warehouse actions to be performed to meet the one or more operational requirements based at least in part on one or more differences between the current operating parameters of the one or more warehouses and the operating parameters of the simulation of operations of the one or more warehouses that meets the one or more operational requirements.

18. The computing system of claim 11, wherein the warehouse management model is trained to operate differently in a plurality of different scenarios, and wherein input the data associated with the one or more warehouses into the warehouse management model to determine the one or more predictive analytics associated with the one or more warehouses further comprises:
inputting, by the one or more processors, the data associated with the one or more warehouses into the warehouse management model operating in a particular scenario out of the plurality of different scenarios to determine the one or more predictive analytics associated with the one or more warehouses.

19. The computing system of claim 18, wherein the plurality of different scenarios include a peace time scenario and a wartime scenario.

20. A non-transitory computer-readable medium storing instructions that, when executed by one or more processors of a computing system, cause the one or more processors to:
receive a predictive analytics request associated with one or more warehouses;
in response to receiving the predictive analytics request, input data associated with the one or more warehouses into a warehouse management model to determine one or more predictive analytics associated with the one or more warehouses, wherein the warehouse management model is trained via machine learning to determine the one or more predictive analytics;
perform simulations of operations of the one or more warehouses based on the one or more predictive analytics to determine one or more warehouse actions to meet one or more operational requirements; and
communicate the one or more warehouse actions to one or more devices associated with the one or more warehouses to enable the one or more devices to operate according to the one or more warehouse actions to meet the one or more operational requirements.
